(19) United States
(12) Patent Application Publication
(10) Pub. No.: US 2013/0329398 A1
(43) Pub. Date: Dec. 12, 2013

(54) DIRECT TYPE BACKLIGHT MODULE STRUCTURE

(71) Applicants: PING-CHEN WU, NEW TAIPEI CITY (TW); WEI-CHUNG LIN, NEW TAIPEI CITY (TW)

(72) Inventors: PING-CHEN WU, NEW TAIPEI CITY (TW); WEI-CHUNG LIN, NEW TAIPEI CITY (TW)

(73) Assignee: UNITY OPTO TECHNOLOGY CO., LTD., NEW TAIPEI CITY (TW)

(21) Appl. No.: 13/603,663

(22) Filed: Sep. 5, 2012

(30) Foreign Application Priority Data
Jun. 8, 2012 (TW) 101120659

(51) Int. Cl. G09F 13/04

(52) U.S. Cl. 362/97.1

(57) ABSTRACT

A direct type backlight module structure combined with a display module includes a plurality of LED light sources aid a diffusion plate, and the LED light sources are arranged into a matrix, and each of the lights emitted from the LED light sources forms a rectangular light pattern separately on the diffusion plate and is transmitted to the display module, so that the rectangular light patterns disposed adjacent to one another can enhance the light mixing effect, improve the light uniformity of the backlight module, and optimize the screen display effect of the display module.

### CROSS-REFERENCE TO RELATED APPLICATIONS

This non-provisional application claims priority under 35 U.S.C. §119(a) on Patent Application No(s). 101120659 filed in Taiwan, R.O.C. on Jun. 8, 2012, the entire contents of which are hereby incorporated by reference.

### BACKGROUND OF THE INVENTION

1. Field of the Invention

The present invention relates to the field of backlight modules applied in liquid crystal displays (LCD), in particular to the direct type backlight module structure for enhancing the light mixing effect to improve the screen displaying effect by changing the formation of light path distribution shape of a light emitting diode (LED) light source.

2. Description of the Related Art

Since liquid crystal display (LCD) is a passive display device without the self-emitting function, therefore it is necessary to add and install a backlight module to

provide a display light source for a display panel, and the condition whether an area light source produced by the backlight module has sufficient and uniform brightness affects the display quality of the liquid crystal display directly. At present, the backlight module can be mainly divided into two types, respectively an edge type backlight module and a direct type backlight module, wherein the direct type backlight module has the features of a high illumination uniformity, a good light-exit viewing angle, a high light energy utility rate, a simple assembly and a quick fine-tune brightness of display areas to enhance the dynamic contrast, and thus the direct type backlight module are applied extensively in large liquid crystal displays. In addition, the LED also has the features of high light emission efficiency, long service life and low power consumption, so that the LED has become the first choice of the applications to the backlight module. In general, a conventional direct type backlight module has a plurality of LED light sources installed on a substrate and arranged into a matrix, and a diffusion plate is covered onto the LED light sources with an appropriate distance apart from the LED light sources for uniformly scattering a light path of the light emitted from each of the LED Sight sources, so that mixed lights can be projected onto a display panel to provide an area light source with uniform brightness.

With reference to FIG. 1 for a schematic view of a light pattern of a conventional direct type backlight module projected on a diffusion plate, a light emitted from the LED light sources forms a circular light pattern 1 on the diffusion plate separately, and adjacent illuminated areas provide full-screen uniform light intensity.

It is noteworthy that a bright portion 10 is formed with the junction, of the adjacent circular light patterns I and a dark portion 11 is formed without any light illumination. Reduce the light mixing effect will affect the uniform illumination adversely, and the liquid crystal display can change the bright and dark areas of the screen to affect the grayscale of adjacent areas on the screen, and thus causing a blooming phenomenon and resulting in lower resolution and saturation of images on screen. Therefore, it is an urgent and important subject for related manufacturers and designers to improve the original light pattern layout of the LED light source and enhance the light mixing effect.

### SUMMARY OF THE INVENTION

In view of the aforementioned problems of the prior art, it is a primary objective of the present invention to provide a direct type backlight module structure for improving the light mixing effect and enhancing the resolution of images on screen by changing the tight pattern of the LED.

To achieve the foregoing objective, the present invention provides a direct type backlight module structure combined with a display module, and the direct type backlight module structure comprises a plurality of LED light sources and a diffusion plate, and the lights emitted from the LED light sources pass through the diffusion plate and then are transmitted to the display module. The direct type backlight module structure of the present invention is characterized in that the LED light sources are arranged into a matrix, and the light emitted from the LED light sources forms a rectangular light pattern on the diffusion plate, and the rectangular light patterns are disposed adjacent one another.

To meet the market requirements and specifications of the display, each of the rectangular light patterns is a regular square and has the same size, or the display module has an aspect ratio of 16:9, and each of the rectangular light patterns is in a rectangular shape and has the same size, and each rectangular light pattern has a long side and a short side, wherein the long side is parallel to a vertical line of the display module, and the short side is parallel to a horizontal line of the display module.

Wherein, each of the rectangular light patterns is formed by a primary optical refraction after each of the lights emitted from the LED light sources passes through a packaging colloid, and the distance L between the LEO light sources and the display module satisfies the relation of 1 mm≦L≦40 mm. The direct type backlight module structure further comprises a plurality of light pattern rectangularization means installed between each of the LED light sources and the diffusion plate, so that each the rectangular light pattern is formed by a secondary optical refraction after each of the lights emitted from the LED light sources is passed through the packaging colloid and then rectangularized by each of the light pattern rectangularization means, and the distance L between the LED light sources and the display module satisfies the relation of 2 mm≦L≦50 mm to maintain the best light pattern and assure the light mixing effect.

To achieve another objective of the present invention, the direct type backlight module structure is combined with a display module, and the direct type backlight module structure comprises a plurality of LED light sources and a diffusion plate, and the lights emitted from the LED light sources are passed through the diffusion plate and then transmitted to the display module. The direct type backlight module structure of the present invention is characterized in that the diffusion plate comprises a plurality of light pattern rectangularization means, installed at a position of a light incident surface where the light emitted from the LED light sources enter into the diffusion plate, and the LED light sources are arranged into a matrix and each of the lights emitted from the LED light sources passes through the light pattern rectangularization means to form a rectangular light pattern separately.

Wherein, the light pattern rectangularization means are a plurality of microlenses arranged into a matrix.

### BRIEF DESCRIPTION OF THE DRAWINGS

FIG. 1 is a schematic view of a light pattern of a conventional direct type backlight module projected on a diffusion plate;

FIG. 2 is a perspective view of a preferred embodiment of the present invention;

FIG. 3 is a schematic view of a light pattern of a direct type backlight module of a preferred embodiment of the present invention projected on a diffusion plate;

FIG. 4 is a cross-sectional view of another preferred embodiment of the present invention;

FIG. 5 is a cross-sectional view of a further preferred embodiment of the present invention;

FIG. 6 is a cross-sectional view of another preferred embodiment of the present invention; and

FIG. 7 is a schematic view of a light pattern of another preferred embodiment of the present invention projected onto a diffusion plate.

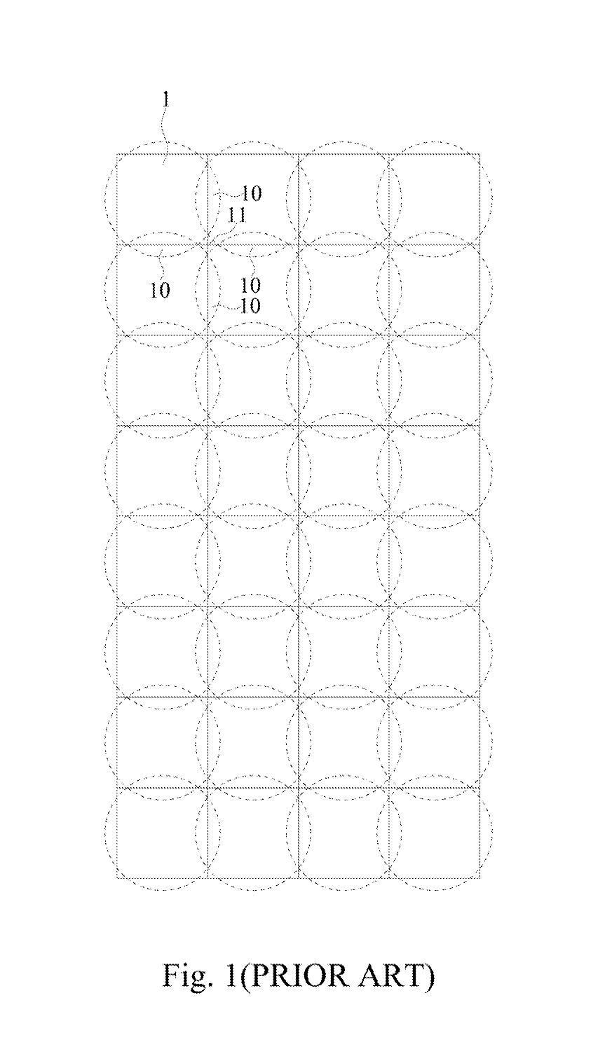

### DETAILED DESCRIPTION OF THE PREFERRED EMBODIMENTS

The technical contents of the present invention will become apparent with the detailed description of preferred embodiments and the illustration of related drawings as follows.

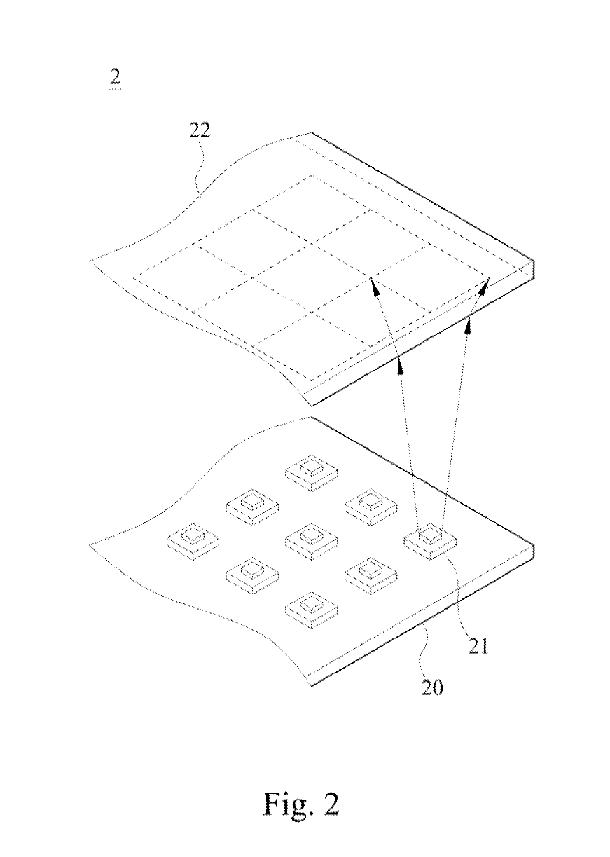

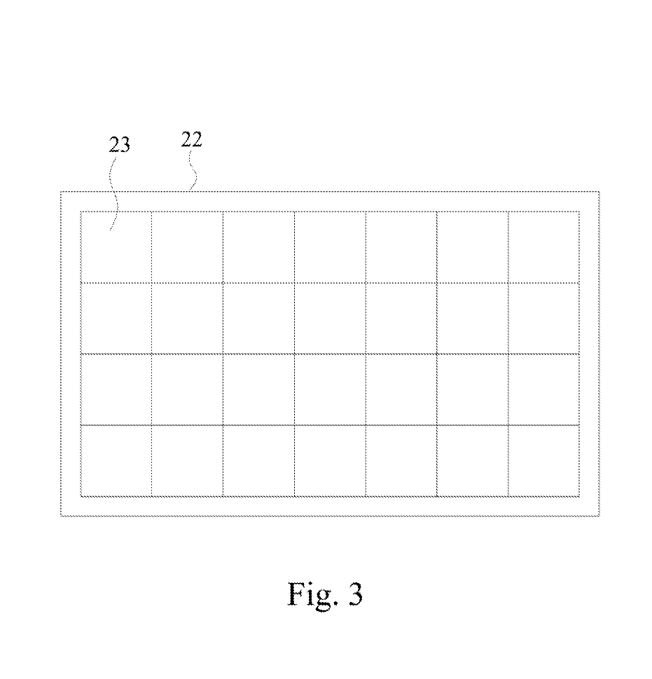

With reference to FIGS. 2 and 3 for a perspective view of a preferred embodiment of the present invention and a schematic view of a light pattern of a direct type backlight module 2 of a preferred embodiment of the present invention projected on a diffusion plate respectively, the direct type backlight module structure 2 is combined with a display module (not shown in the figure) such as an LCD panel with an aspect ratio of 16:9 to provide a light source. The direct type backlight module structure 2 comprises a substrate 20, a plurality of LED light sources 21 and a diffusion plate 22, wherein the LED light sources 21 are arranged into a matrix on the substrate 20, and the diffusion plate 22 is covered onto the LED light sources 21 with an appropriate distance apart and provided for scattering the light emitted from the LED light sources 21 and then transmitting the light to the display module. The lights emitted from the LED light sources 21 form a rectangular light pattern 23 on the diffusion plate 22 separately, and each of the rectangular light pattern 23 in a square shape has the same size and the rectangular light patterns 23 are disposed adjacent to one another to enhance the light uniformity, so as to provide a full-screen light uniform luminance to the direct type backlight module structure 2.

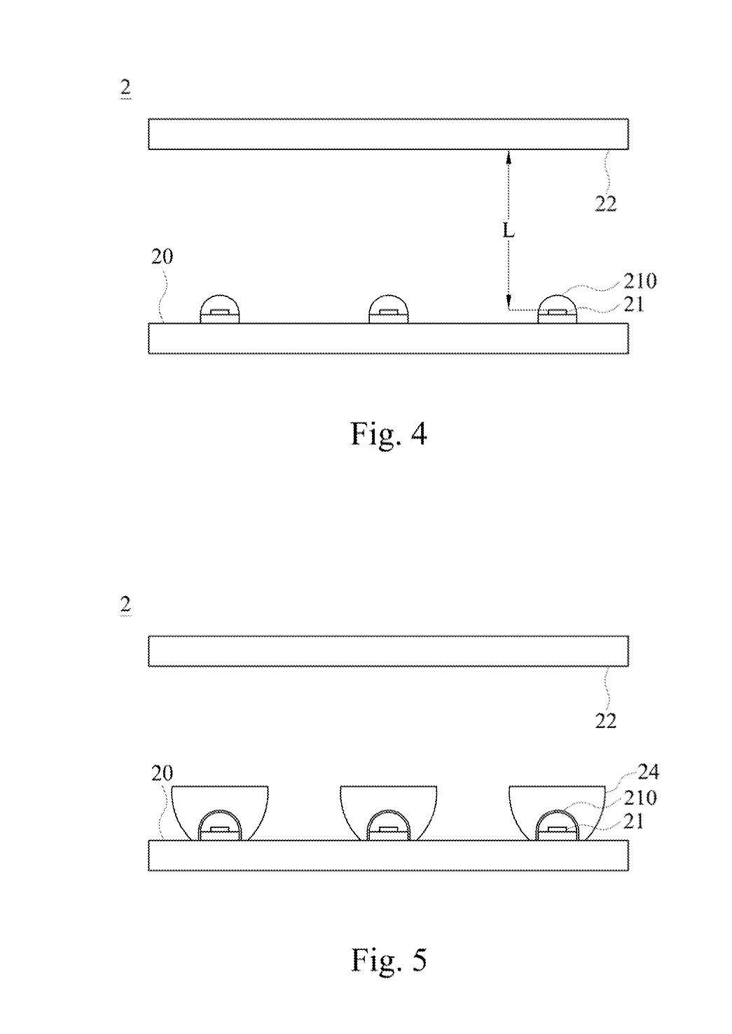

With reference to FIG. 4 tor a cross-sectional view of a direct type backlight module structure in accordance with a second preferred embodiment of the present invention, each of the lights emitted from the LED light sources 21 of the direct type backlight module structure 2 passes through a packaging colloid 210 for a primary optical refraction to form the rectangular light patterns 23 to optimize the light pattern distribution, and a distance L between the LED light sources 21 and the display module satisfies the relation of 1 mm≦L≦40 mm to maintain the best light pattern and uniformize the light irradiation.

With reference to FIG. 5 for a cross-sectional view of a direct type backlight module structure 2 in accordance with a further preferred embodiment of the present invention, a plurality of light pattern rectangularization means are adopted; for example, the distance L between the LED light sources 21 and the display module satisfies the relation of 2 mm≦L≦50 mm. In the meantime, the plurality of microlenses 24 is installed between each of the LED light sources 21 and the diffusion plate 22 to cover each of the LED light sources 21, so that after each of the lights emitted from the LED light source 21 passes through the packaging colloid 210 and then through each of the microlenses 24 for a secondary optical retraction to form each of the rectangular light patterns 23 separately. Therefore, the light pattern rectangularization means can improve the light path direction and the illumination distribution of the LED light sources 21 to provide a better light pattern and enhance the resolution of the display module.

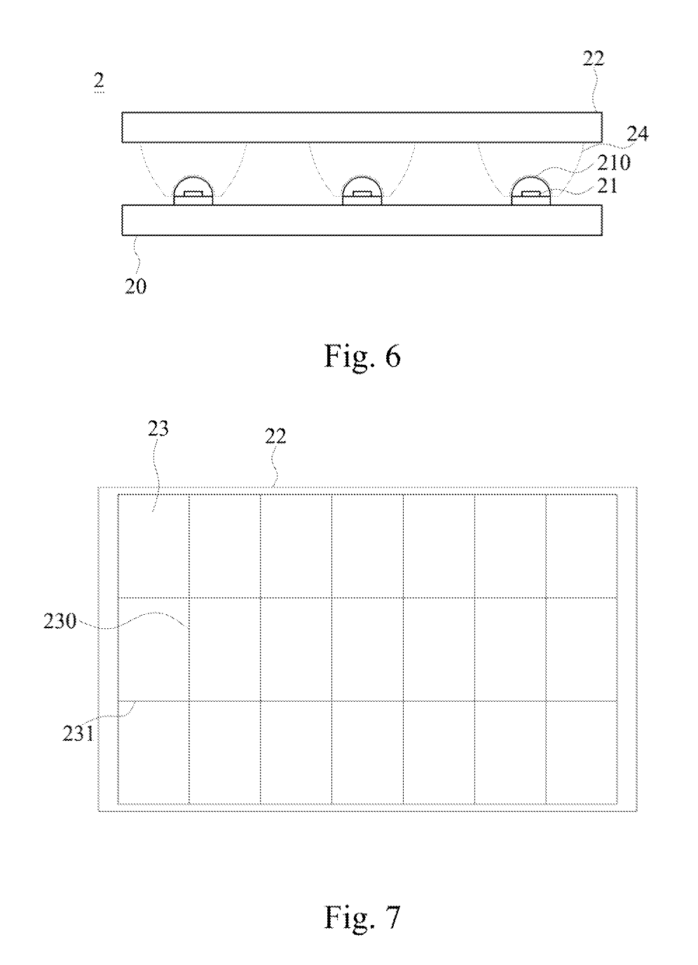

With reference to FIGS. 6 and 7 for a cross-sectional view of a preferred embodiment of the present invention and a schematic view of a light pattern of a direct type backlight module of another preferred embodiment of the present invention projected on a diffusion plate respectively, the direct type backlight module structure 2 is applied in a liquid crystal display (LCD) for providing an Illumination source to a display module (not shown in the figure), and the direct type backlight module structure 2 comprises a substrate 20, a plurality of LED light sources 21 and a diffusion plate 22, wherein the LED light sources 21 are arranged into a matrix on the substrate 20 and covered onto the diffusion plate 2, and the diffusion plate 22 comprises a plurality of light pattern rectangularization means; for example the light pattern regularization means are plurality of microlenses 24 arranged into a matrix and installed at a position of a light incident surface wherein the light emitted from the LED light sources 21 enters into the diffusion plate 22, so that after each of the lights emitted from the LED light sources 21 passes through the microlenses 24 to enter into the diffusion plate 22, a rectangular light pattern 23 is formed separately and the lights are mixed uniformly and transmitted to the display module to display images on screen normally.

In this preferred embodiment, each of the rectangular light patterns 23 is in a rectangular shape and has the same size, and each rectangular light pattern 23 has a long side 230 and a short side 231, wherein the long side 230 is parallel to a vertical line of the display module, and the short side 231 is parallel to a horizontal line of the display module. Therefore, the close adjacent distribution of the rectangular Sight patterns 23 achieved by the rectangularization can enhance the full-screen light uniformity of the display module significantly.

What is claimed is:

1. A direct type backlight module structure, combined with a display module, comprising a plurality of LED light sources and a diffusion plate, and light emitted from the LED light sources passing through the diffusion plate and then being transmitted to the display module, characterized in that the LED light sources are arranged into a matrix, and the light emitted from the LED light sources forms a rectangular light pattern on the diffusion plate, and the rectangular fight patterns are disposed adjacent one another.

2. The direct type backlight module structure of claim 1, further comprising: a plurality of light pattern rectangularization means installed between each of the LED light sources and the diffusion plate, so that each the rectangular light pattern is formed by a secondary optical refraction after each of light emitted from the LED light sources is passed through the packaging colloid and then rectangularized by each of the light pattern rectangularization means.

3. The direct type backlight module structure of claim 2, wherein the distance L between the LED light sources and the display module satisfies the relation of 2 mm≦L≦50 mm.

4. The direct type backlight module structure of claim 1, wherein each of the rectangular light patterns is in a regular square shape and has the same size.

5. The direct type backlight module structure of claim 4, further comprising: a plurality of light pattern rectangularization means installed between each of the LED light sources and the diffusion plate, so that each the rectangular light pattern is formed by a secondary optical refraction after each of light emitted from the LED light sources is passed through the packaging colloid and then rectangularized by each of the light pattern rectangularization means.

6. The direct type backlight module structure of claim 5, wherein the distance L between the LED light sources and the display module satisfies the relation of 2 mm≦L≦50 mm.

7. The direct type backlight module structure of claim 1, wherein each of the rectangular light pattern is in a rectangular shape and has the same size, and each, of the rectangular light patterns has a long side and a short side, and the long side is parallel to a vertical line of the display module, and the short side is parallel to a horizontal line of the display module.

8. The direct type backlight module structure of claim 7, further comprising: a plurality of light pattern rectangularization means installed, between each of the LED fight sources and the diffusion plate, so that each the rectangular light pattern Is formed by a secondary optical refraction after each of light emitted front the LED light sources is passed through the packaging colloid and then rectangularized by each of the light pattern rectangularization means.

9. The direct type backlight module structure of claim 8, wherein the distance L between the LED light sources and the display module satisfies the relation, of 2 mm≦L≦50 mm.

10. The direct type backlight module structure of claim 1, wherein the display module has an aspect ratio of 16:9.

11. The direct type backlight module structure of claim 10, further comprising: a plurality of light pattern rectangularization means installed between each of the LED light sources and the diffusion plate, so that each the rectangular light pattern is formed by a secondary optical retraction after each of light emitted from the LED light sources is passed through the packaging colloid and then rectangularized by each of the light pattern rectangularization means.

12. The direct type backlight module structure of claim 11, wherein the distance L between the LED light sources and the display module satisfies the relation, of 2 mm≦L≦50 mm.

13. The direct type backlight module structure of claim 1, wherein each of the rectangular light patterns is formed by a primary optical refraction after each of lights emitted from the LED light sources passes through a packaging colloid.

14. The direct type backlight module structure of claim 13, wherein the distance L between the LED light sources and the display module satisfies the relation of 1 mm≦L≦50 mm.

15. The direct type backlight module structure of claim 13, further comprising: a plurality of light pattern rectangularization means installed between each of the LED light sources and the diffusion plate, so that each the rectangular light pattern is formed by a secondary optical refraction after each of light emitted from the LED light sources is passed through the packaging colloid and then rectangularized by each of the light pattern rectangularization means.

16. The direct type backlight module structure of claim 15, wherein the distance L between the LED light sources and the display module satisfies the relation of 2 mm≦L≦50 mm.

17. A direct type backlight module structure, combined with a display module, comprising a plurality of LED light sources and a diffusion plate, and light emitted from the LED light sources passing through the diffusion plate and then being transmitted to the display module, characterized in that the diffusion plate comprises a plurality of light pattern rectangularization means, installed at a position of a light incident surface where the lights emitted from the LED light sources enter into the diffusion plate, and the LED light sources are arranged into a matrix and lights emitted from the LED light sources pass through the light pattern rectangularization means to form a rectangular light pattern separately.

18. The direct type backlight module structure of claim 17, wherein the light pattern rectangularization means are a plurality of microlenses arranged into a matrix.
